(19) United States
(12) Patent Application Publication
(10) Pub. No.: US 2007/0064969 A1
(43) Pub. Date: Mar. 22, 2007

(54) Glasses with an audio transceiver

(76) Inventor: Chia Lin Chou, Taipei (TW)

Correspondence Address: CHOU CHIA LIN, 235 Chung-Ho, Box 8-24, Taipei, TW

(21) Appl. No.: 11/230,620

(22) Filed: Sep. 21, 2005

(51) Int. Cl. H04R 25/00

(52) U.S. Cl. 381/381

(57) ABSTRACT

A pair of glasses with an audio transceiver comprises a pair of glasses having a frame; a base portion installed in the glasses; the base portion having a plurality of adjusting buttons; at least one blue tooth module in the base portion; the blue tooth module being connected to at least one microphone for recording music; the blue tooth module can be connected to a notebook computer, a PDA, a handset, a motophone, or other communication system or network; and a battery installed in the frame of the glasses; the battery being connected to the base portion through conductive wires; the battery installed with a plurality of adjusting buttons for adjusting the functions of receiving, playing and recording music.

### FIELD OF THE INVENTION

The present invention relates to glasses, and in particular to a glasses with an audio transceiver, wherein the present invention can be connected to a network by wired or wireless way. Thereby the music in motophone or MP3 or PDA can be received by wireless blue tooth modules. The glasses can be separated from the microphone-earphone set. The glasses can be combined to a hooking earphone for receiving music.

### BACKGROUND OF THE INVENTION

Generally, the music from a handset is only single-channel music. If an earphone is plugged in the ear for a longer time, the ear will feel uneasy. In the prior art, there are many kinds of music players, such as motophone, MP3, PDA handsets, notebook computers, etc. However all these devices are used with earphones. There are many kinds of players and earphones. The specifications of earphones are not unified. Thereby different earphones cannot replace to one another. If the users desire to carry several earphones together, the user will feel inconvenient. Thereby it is inconvenient as the user holds a handset for hearing a music as the user runs, walks, or plays a computer. Furthermore, the conventional earphones easily fall down or break as pulled by a strong force or many times. Thus the user cannot hear music comfortably.

### SUMMARY OF THE INVENTION

Accordingly, the primary object of the present invention is to provide a pair of glasses with an audio transceiver, wherein the present invention can be connected to a network wired or wirelessly. Thereby, the music in motophone, MP3 or PDA can be received by wireless blue tooth modules. The glasses can be separated from the microphone-earphone set. The glasses can be combined to a hooking earphone for receiving music.

To achieve above object, the present invention provides a pair of glasses with an audio transceiver which comprises a pair of glasses having a frame; a base portion installed in the glasses; the base portion has a plurality of adjusting buttons; at least one blue tooth module in the base portion; the blue tooth module being connected to at least one microphone for recording music; the blue tooth module can be connected to a notebook computer, a PDA, a handset, or other communication system or network; and a battery installed in the frame of the glasses; the battery being connected to the base portion through conductive wires; the battery installed with a plurality of adjusting buttons for adjusting the functions of receiving, playing and recording music.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a first perspective view of another embodiment in the present invention.

FIG. 3 is a second perspective view of another embodiment in the present invention.

FIG. 4 is a third perspective view of another embodiment in the present invention.

FIG. 5 is a fourth perspective view of another embodiment in the present invention.

FIG. 6 is a fifth perspective view of another embodiment in the present invention.

FIG. 7 is a sixth perspective view of another embodiment in the present invention.

FIG. 8 is a seventh perspective view of another embodiment in the present invention.

FIG. 9 is an eighth perspective view of another embodiment in the present invention.

FIG. 10 is a ninth perspective view of another embodiment in the present invention.

FIG. 11 is a tenth perspective view of another embodiment in the present invention.

FIG. 12 is an eleventh perspective view of another embodiment in the present invention.

FIG. 13 is a twelfth perspective view of another embodiment in the present invention.

FIG. 14 is a thirteen perspective view of another embodiment in the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

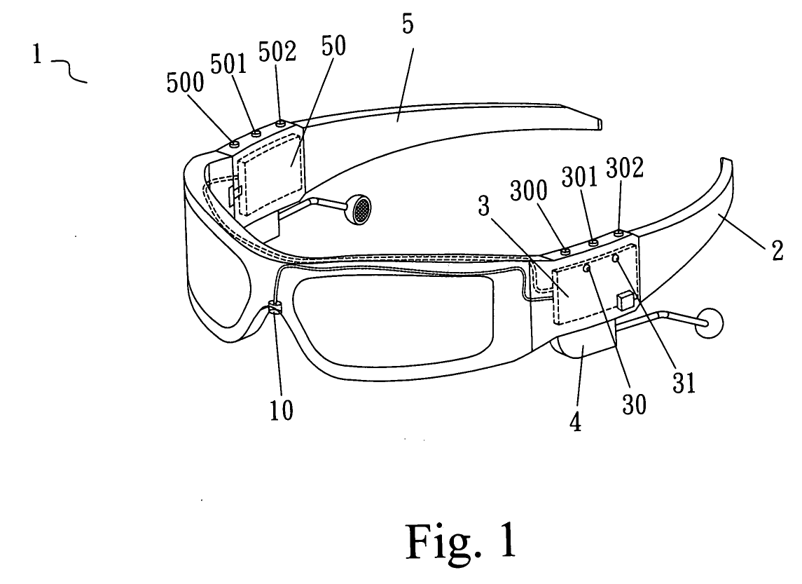

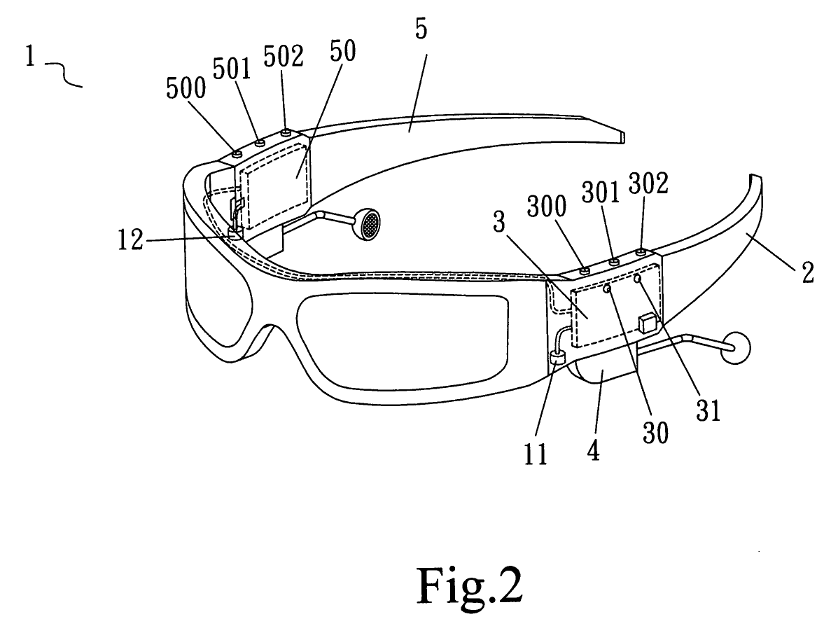

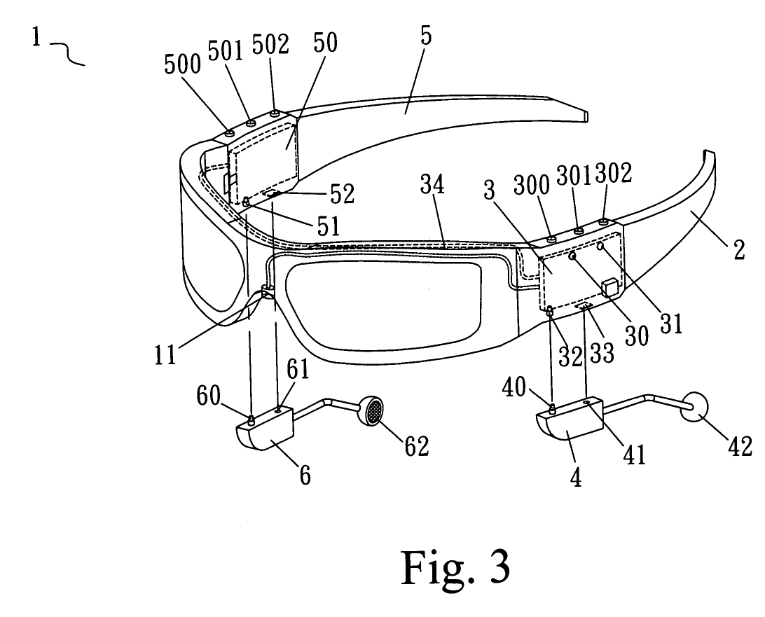

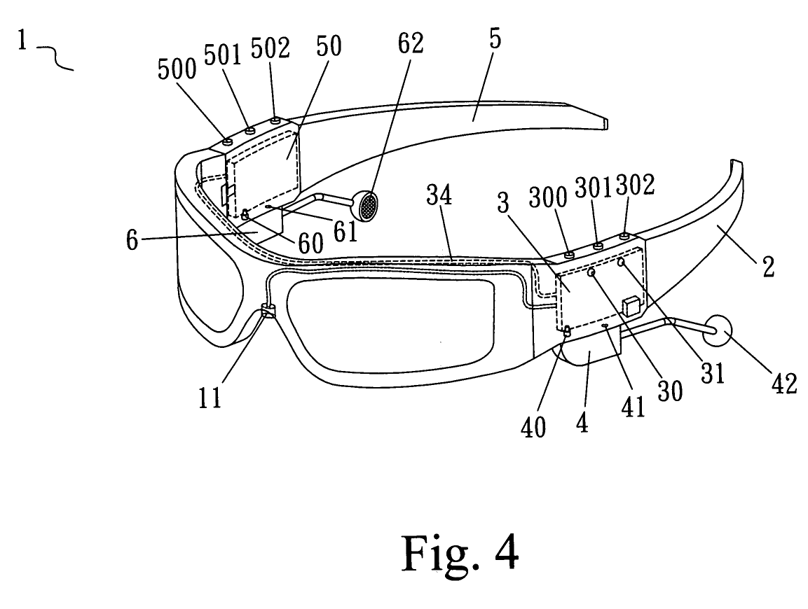

Referring to FIGS. 1 to 4, the glasses with an audio transceiver of the present invention is illustrated. The structure of the present invention will be described herein.

A pair of glasses 1 has a frame 2.

A base portion 3 is installed in the glasses 1. The base portion 3 has a plurality of adjusting buttons 300, 301, 302 for selecting the functions of MP3 music, blue tooth earphone receiving, selection of music, and volume control.

At least one blue tooth module is in the base portion 3. The blue tooth module is connected to at least one microphone 10 for recording music. The blue tooth module can be connected to a notebook computer, a PDA, a handset, motophone, or other communication system or network.

At least one microphone-earphone set is installed at a lower edge of the frame 2 of the glasses 1. In this the present invention, there are two microphone-earphone sets 4 and 6 are illustrated.

A plurality of indication lamps 30, 31 expose from a lateral side of the base portion 3 as an indication of power source.

A receptacle 32 is installed at a lower side of the base portion 3 for receiving a plug 40 of the microphone-earphone set 4. One side of the receptacle 32 is installed with an iron sheet 33 which is connected to a magnet 41 of the microphone-earphone set 4 so that iron sheet 33 is attractable with the magnet 41. Thereby the microphone-earphone set 4 can be fixed to a lower edge of the frame 2.

The microphone-earphone set has an earphone 42, 62 for receiving music.

A battery 50 is installed in the frame 2 of the glasses 1. The battery 50 is connected to the base portion 3 through conductive wires. The battery 50 is installed with a plurality of adjusting buttons 500, 501, 502 for adjusting the functions of receiving, playing and recording music.

A further receptacle 51 is installed at a lower side of the battery 50 for receiving a plug 60 of the microphone-earphone set 6. One side of the receptacle 51 is installed with an iron sheet 52 which is connected to a magnet 61 of the microphone-earphone set 6 so that iron sheet 62 is attractable with the magnet 61. Thereby the microphone-earphone set 6 can be fixed to a lower edge of the frame 2.

In the present invention, when the microphone-earphone sets 4, 6 are detached from the glasses 1, the glasses 1 are used as a normal glasses 1.

The base portion 3 includes a memory for storage of audio data, such as music or document.

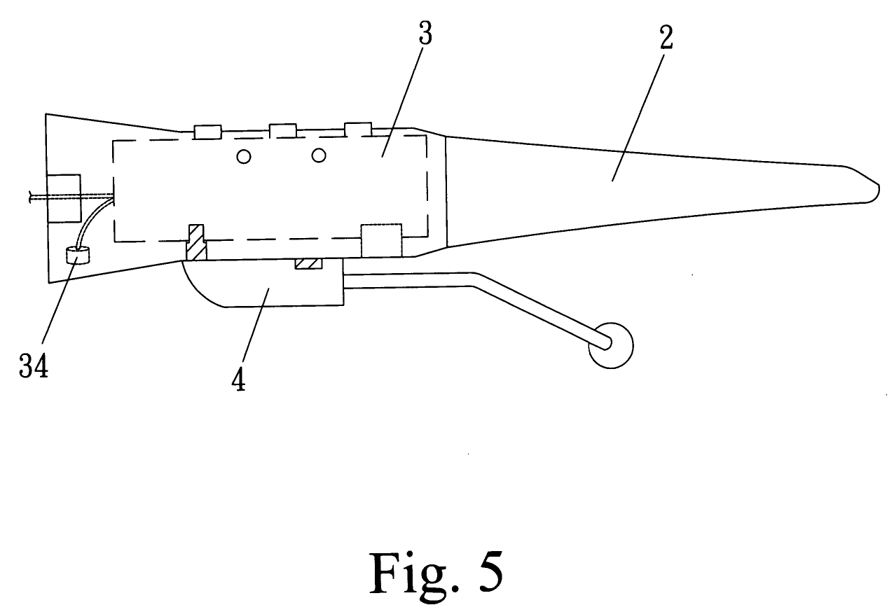

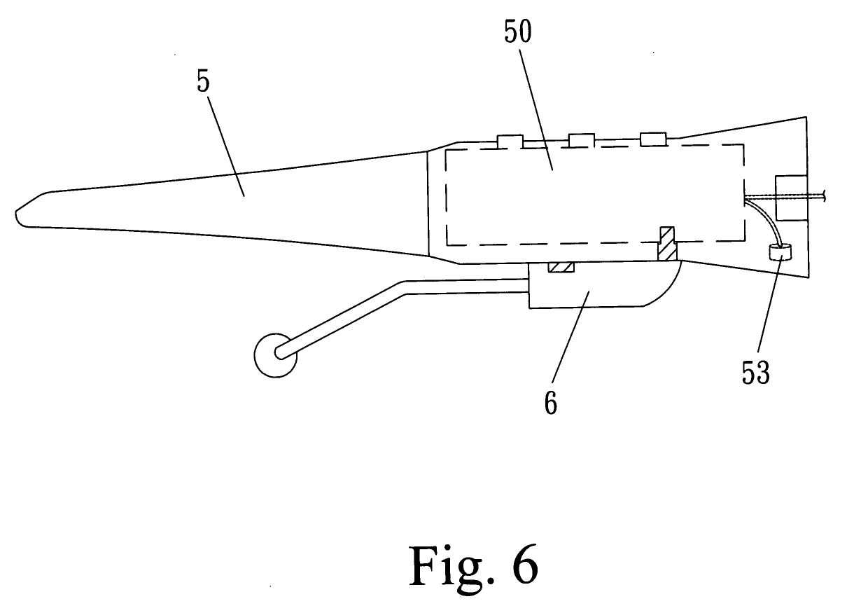

Referring to FIGS. 5 and 6, a left frame 2 is extended with a microphone 34 and another frame 5 is extended with a further microphone 53 so that the sound can be received at two sides to have preferred sound effect.

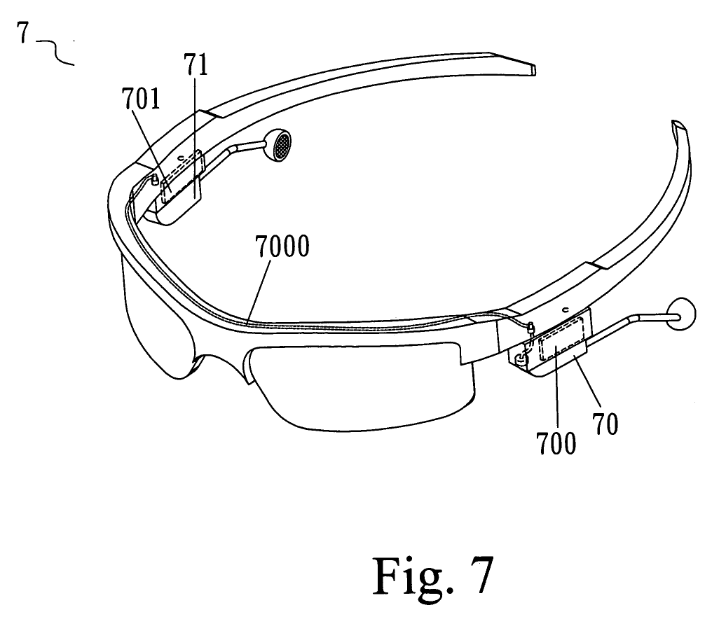

With reference to FIG. 7, in the present invention, the base portion 700 is installed within the microphone-earphone set 70. The battery 701 is installed in another microphone-earphone set 71. The two microphone-earphone sets 700, 701 are inserted below the glasses 7, which are connected by a conductive wire 7000 as a power connection. The microphone-earphone set 70 has a memory as a portable memory.

The microphone-earphone sets 70, 71 can be used to connect a PDA handset, or a blue tooth handset for receiving information. When the microphone-earphone sets 70, 71 are detached from the glasses 1, the glasses 1 is used as a pair of normal glasses 1. When it is attached to the glasses 1, the glasses 1 can receive music.

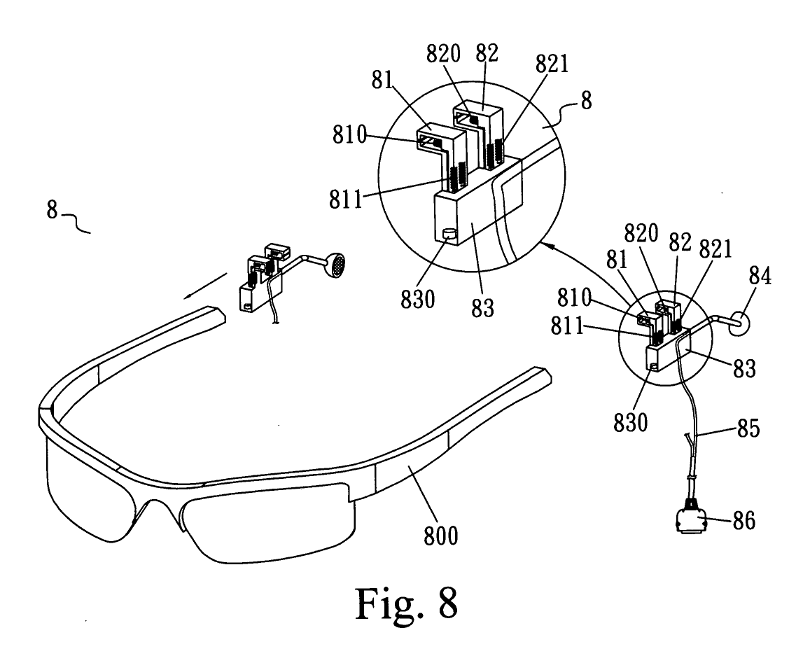

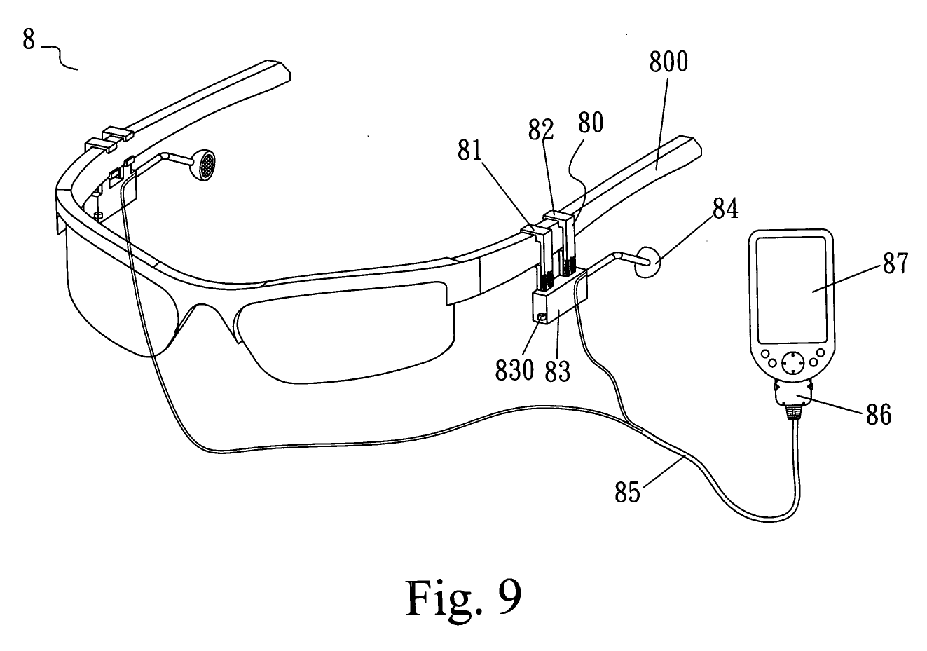

Referring to FIGS. 8 and 9, in the present invention, the glasses 1 can be used with a hooking earphone 80. Two L shape hooks 81, 82 extend from an upper side of the hooking earphone 80. Each hooking earphone 80 has a recess. A spring 810, 820 is installed in the recess for tightly resisting the frame 800. A bottom of the L shape hook 81, 82 is installed with a spring 811, 821 is connected to a seat 83 of the earphone so as to increase the tightness of the L shape hook to the seat. An earphone seat 83 has one end connected to the L shape hook 81 and another end connected to one leg of the frame 800 so as to be hooked to a lateral side of the glasses 8. A microphone 830 is installed at a front end of the earphone seat 83. A rear end of the earphone seat 83 is connected to an earphone 8 and to a plug 86 through a cable 85 so as to be further connected to a digital panel 87, such as a handwriting input panel. The hooking earphone 80 may be further connected to a notebook computer, a PDA, a handset, a blue tooth handset, a motophone (phone used within a vehicle or a motor), and other network.

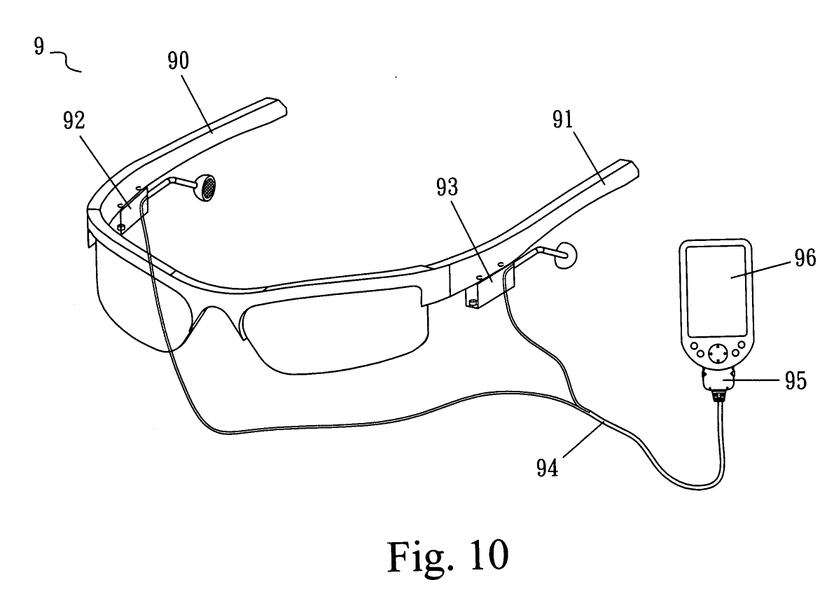

Referring to FIG. 10, microphone-earphone sets 92, 93 below the frames 90, 91 of the glasses 9 serve to connect a handwriting input panel 96 through the plug 95 and the cable 94 and to be connected to a computer for networking.

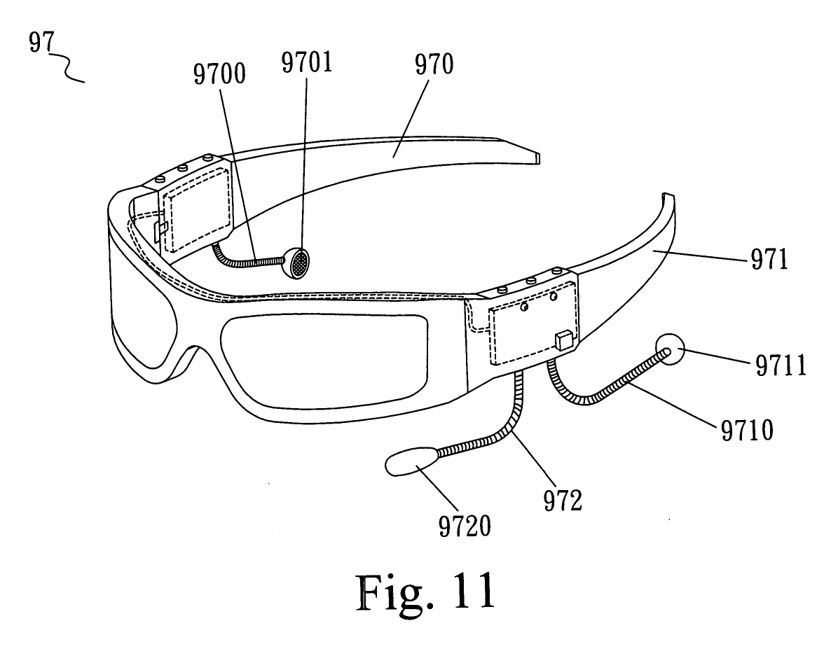

Referring to FIG. 11, in this embodiment, lower ends of the frames 970, 971 of the glasses 97 extend with bendable soft tubes 9700, 9710 which are connected to the earphones 9701, 9711 so as to be adhered to the ears of users. The glasses 97 extend with a soft tube 972 which is then connected to a microphone 9720 so that the microphone can be adjusted to a preferred position to the user.

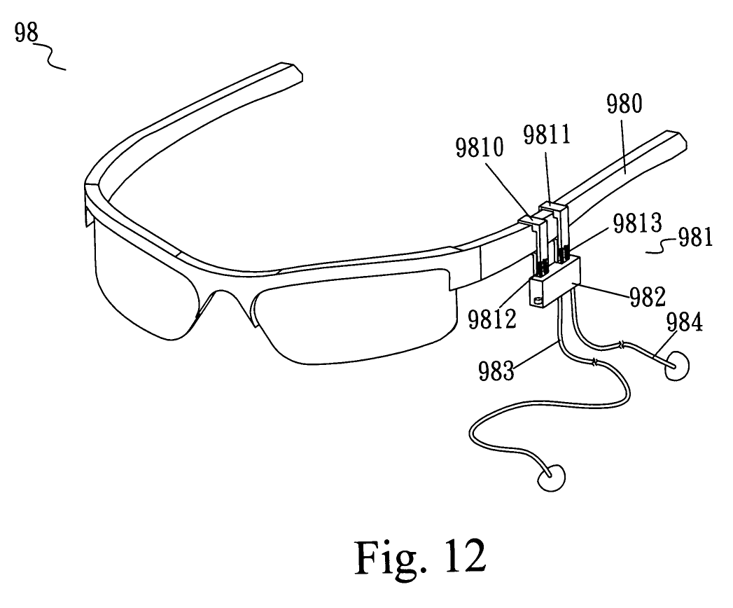

Referring to FIG. 12, in this embodiment, a hooking earphone 981 is attached to the frame 980 of the glasses 98. L shape hooks 9810, 9811 extended from an upper side of the hooking earphone 981. A bottom of each L shape hook 9810, 9811 is installed with a spring 9812, 9813 to be connected to an earphone seat 982 located below so as to increase the tightness. The hooking earphone 981 is attached to a distal end of the frame 980 so that the hook is installed to a lateral side of the glasses 8. A lower side of the hooking earphone 981 extends with two earphone wires 983, 984.

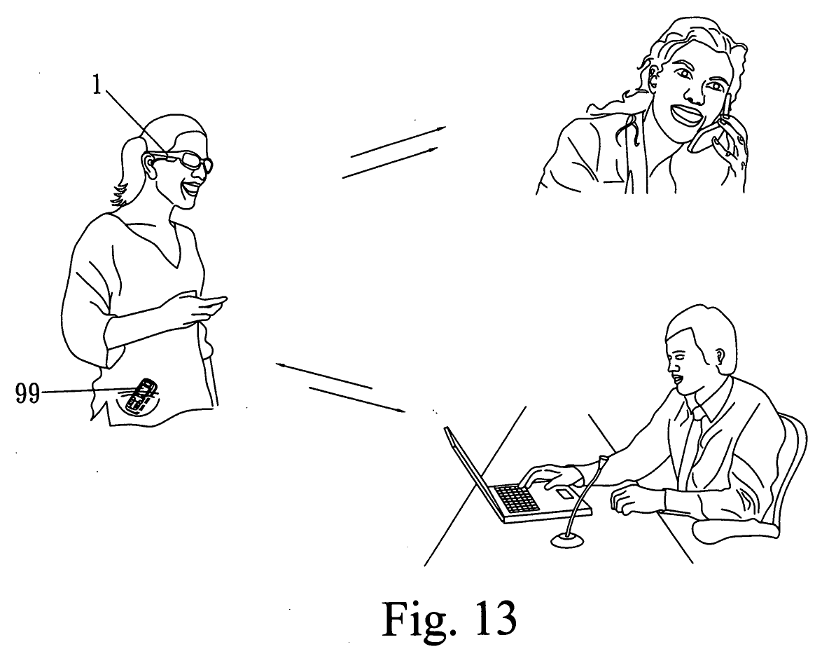

Referring to FIG. 13, an application of the present invention is illustrated. It is illustrated that by the present invention, the user can communicate through the blue tooth module in the glasses 1 or in a mobile phone 90. Thereby the operation of hands of the user is not affected. The defects in operating handsets or computers can be avoided by the design of the present invention.

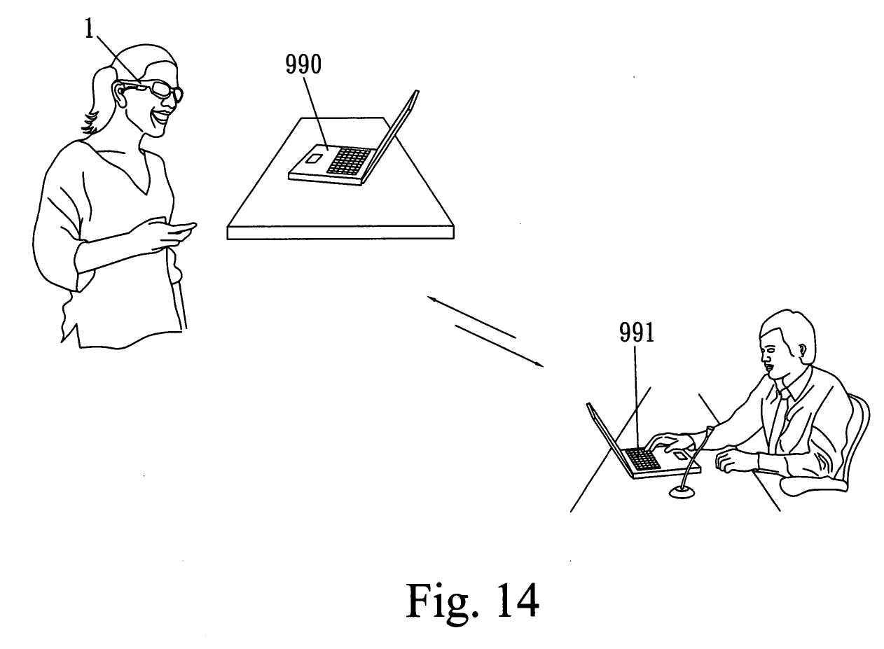

Referring to FIG. 14, the glasses 1 of the present invention is connected to a blue tooth device, such as a notebook computer, a handwriting PDA. The two notebook computers 990, 991 are connected, wherein the notebook computer 990 is connected to the glasses 1 of the present invention.

Advantages of the present invention is that the present invention can be connected to a network wired or wirelessly. Thereby the music in MP3 or PDA or a motophone can be received by wireless blue tooth modules. The glasses can be separated from the microphone-earphone set. The glasses can be combined to a hooking earphone for receiving music.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pair of glasses with an audio transceiver comprising:
a pair of glasses having a frame;
a base portion installed in the glasses; the base portion having a plurality of adjusting buttons;
at least one blue tooth module in the base portion; the blue tooth module being connected to at least one microphone for recording music; the blue tooth module can be connected to a notebook computer, a PDA, a handset, a motophone, or other communication system or network;
a battery installed in the frame of the glasses; the battery being connected to the base portion through conductive wires; the battery installed with a plurality of adjusting buttons for adjusting the functions of receiving, playing and recording music.

2. The glasses with an audio transceiver as claimed in claim 1, wherein the plurality of adjusting buttons serve for selecting the functions of MP3 music, blue tooth earphone receiving, selection of music, and volume control.

3. The glasses with an audio transceiver as claimed in claim 1, further comprising a plurality of indication lamps expose from a lateral side of the base portion as an indication of power source.

4. The glasses with an audio transceiver as claimed in claim 1, wherein at least one microphone is installed at a lower edge of the frame of the glasses.

5. A pair of glasses with an audio transceiver comprising:
a pair of glasses having a frame;
at least one microphone-earphone set installed at a lower edge of the frame of the glasses; the microphone-earphone set being detachable from the glasses;
a base portion installed in the microphone-earphone set;
a battery installed in the microphone-earphone set; the microphone-earphone set being installed at a lower side of the glasses; the battery being connected to the base portion through conductive wires; the microphone-earphone set being installed with a memory; the microphone.-earphone set being capable of being connected to a network to a computer, a PDA handset, a motophone, through a blue tooth module in the microphone-earphone set.

6. The glasses with an audio transceiver as claimed in claim 5, wherein there are two microphone-earphone sets are illustrated.

7. The glasses with an audio transceiver as claimed in claim 5, wherein a receptacle is installed at a lower side of the base portion for receiving a plug of the microphone-earphone set; one side of the receptacle is installed with an iron sheet which is connected to a magnet of the microphone-earphone set so that iron sheet is attractable with the magnet; an earphone extends from the microphone-earphone set.

8. The glasses with an audio transceiver as claimed in claim 5, wherein a receptacle is installed at a lower side of the battery for receiving a plug of the microphone-earphone set; one side of the receptacle is installed with an iron sheet which is connected to a magnet of the microphone-earphone set so that iron sheet is attractable with the magnet; thereby the microphone-earphone set is fixed to a lower edge of the frame.

9. A glasses with an audio transceiver as claimed in claim 1, wherein the glasses is used with a hooking earphone comprising:
two L shape hooks extending from an upper side of the hooking earphone; each hooking earphone having a recess;
each recess being installed with a first spring for tightly resisting the frame;
a bottom of the L shape hook being installed with a spring which is connected to an earphone seat of the earphone so as to increase the tightness of the L shape hook to the seat;
an earphone seat having one end connected to the L shape hook and another end connected to one leg of the frame so as to be hooked to a lateral side of the glasses; and
a microphone installed at a front end of the earphone seat; a rear end of the earphone seat being connected to an earphone and to a plug through a cable so as to be further connected to a digital panel; the hooking earphone being further connected to a notebook computer, a PDA, a handset, a blue tooth handset, a motophone, and other network.

10. The glasses with an audio transceiver as claimed in claim 9, wherein the digital panel is a handwriting electronic panel.

11. A pair of glasses with an audio transceiver comprising:
a pair of glasses having a frame;
lower ends of the legs of the frames of the glasses extending with bendable soft tubes which are connected to the earphones so as to be adhered to the ears of users; the glasses extending with a soft tube which is then connected to a microphone so that the microphone can be adjusted to a preferred position to the user.

12. The pair of glasses with an audio transceiver as claimed in claim 11, further comprising:
a hooking earphone attached to the frame of the glasses; L shape hooks extended from an upper side of the hooking earphone; a bottom of each L shape hook being installed with a spring to be connected to an earphone seat located below so as to increase the tightness; the hooking earphone being attached to a distal end of the frame so that the hook is installed to a lateral side of the glasses; and a lower side of the hooking earphone extending with two earphone wires.
